(19) United States
(12) Patent Application Publication
(10) Pub. No.: US 2011/0133144 A1
(43) Pub. Date: Jun. 9, 2011

(54) PORTABLE CATTLE GUARD AND METHOD THEREFOR

(76) Inventor: Gary Miller, Globe, AZ (US)

(21) Appl. No.: 12/962,248

(22) Filed: Dec. 7, 2010

Related U.S. Application Data
(60) Provisional application No. 61/267,427, filed on Dec. 7, 2009.

(51) Int. Cl. A01K 3/00

(52) U.S. Cl. 256/17

(57) ABSTRACT

A cattle guard has a grate section, wherein the grate section is arced shaped and is positioned on a ground. An end member is hingedly coupled to the grate section. The end member allows the cattle guard to adjust to conform to different fence openings.

### RELATED APPLICATIONS

The present application is related to U.S. Provisional Patent Application entitled, “Universal Cattle Guard”, Filed Dec. 7, 2009, having U.S. Ser. No. 61/267,427, in the name of the same inventor, and which is incorporated herein by reference in its entirety. The present application further claims the benefit of the aforementioned.

### BACKGROUND

Embodiments of this disclosure relate generally to A cattle guard and, more particularly, to a cattle guard which is portable that may be used in multiple locations and further does not require any type of pit to be dug for installation.

Cattle guards may be used as a type of obstacle to prevent livestock from passing through an opening in fencing that may be surrounding a piece of property. Cattle guards are usually installed over roads where they cross a fence line, often at a boundary between public and private lands. Cattle guards may be used as an alternative to the erection of gates that would need to be opened and closed every time a vehicle passed, and are common where roads cross open moorland, rangeland or common land maintained by grazing, but where segregation of fields is impractical.

Prior art cattle guards generally require that a trench/pit be dug in the road between the fence posts where the cattle guard is to be installed. The trench/pit is generally covered by a transverse grid of bars or tubes, normally made of metal and firmly fixed to the ground on either side of the trench/pit. In general, gaps are formed between the bars. The gaps are generally wide enough for animals' legs to fall through, but sufficiently narrow not to impede a wheeled vehicle. Cattle will generally not cross the cattle guard since the bars over the trench/pit do not provide adequate footing.

Current conventional cattle guards have many problems. First, many conventional cattle guards require pits to be dug to allow installation. The pits are inconvenient and expensive to install. Further, the pit is not wildlife friendly as small animals may fall in the pit and become trapped without a means of egress. For conventional cattle guards that do not require a pit, expensive mechanical features are generally required. These mechanical features generally wear out and are subject to mechanical failure. Further, typical cattle guards that do not require a pit are complex in nature and generally not practical for everyday use, with trailers etc. Conventional cattle guards are also permanent fixtures. Thus, current conventional cattle guards may only be utilized for one specific location. Further, conventional cattle guards have bar spacing to form a grating that is wide enough to allow a large animal's legs to fit between the bars, and a distance to solid ground deep enough to make it unable for the animal to extricate itself without causing serious injury. Unfortunately, many times, when cattle are trapped in conventional cattle guards, the cattle tend to injure themselves trying to escape. The injured cattle frequently have to be euthanatized.

Therefore, it would be desirable to provide a system and method that overcomes the above.

### SUMMARY

In accordance with one embodiment, a cattle guard is disclosed. The cattle guard has a grate section, wherein the grate section is arced shaped and is positioned on a ground. An end member is hingedly coupled to the grate section. The end member allows the cattle guard to adjust to conform to different fence openings.

In accordance with another embodiment, a cattle guard is disclosed. The cattle guard has a plurality of pole members, the pole members placed on a ground area and arranged to form an arc. A pair of end member is hingedly coupled to a pair of sides of the pole members, the end members allowing the cattle guard to adjust to conform to different size fence openings.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1A is a top view of one embodiment of the present invention;

FIG. 1B is a front view of the embodiment shown in FIG. 1A;

FIG. 1C is a side view of the embodiment shown in FIG. 1A;

FIG. 2 is a magnified view of the end members used in the embodiment shown in FIG. 1A;

FIG. 3 is a magnified view of a side plate member used in the embodiment shown in FIG. 1A;

FIG. 4A is a top view of another embodiment of the present invention;

FIG. 4B is a front view of the embodiment shown in FIG. 4A;

FIG. 4C is a side view of the embodiment shown in FIG. 4A; and

FIG. 5 is a magnified view of a side plate member used in the embodiment shown in FIG. 4A.

### DETAILED DESCRIPTION

The present invention is a cattle guard. The cattle guard overcomes many of the issues with current designs. The cattle guard sits on top of the ground and therefore requires no pit. The cattle guard is completely portable and designed with side guards that facilitate the ease of installation between any two gate posts. The cattle guard has spacing designed narrowly enough to prevent a large animal from stepping through to solid ground and wide enough to present a deterrent. The cattle guard is maintenance friendly due to clean out procedures which require only dragging the cattle guard a few feet and then returning it to the desired position. Dragging the cattle guard re-levels the roadway under the cattle guard, and removes dirt and debris from between the rails of the cattle guard. The cattle guard eliminates the expense of pouring concrete as well as eliminating the concrete footing that large animals tend to traverse. The cattle guard utilizes the fact that the rounded nature of pipe provides unsuitable footing for hoofed animals, consequently making it virtually impossible for a hoofed animal to walk across; therefore being superior to square or flat materials used in most cattle guards. The cattle guard is simple in design utilizing only spacing that is inadequate for a large animal to get its foot through, and the fact that the arc of the pipe provides inadequate footing for hoofed animals, eliminating a need for expensive mechanical parts. The cattle guard has no moving parts that could potentially pop-up at an inopportune time and catch a trailer hitch, jack, etc. The sleek design of the cattle guard allows for a vehicle and trailer to pass without dragging, by providing a uniform arc keeping vehicle and trailer on similar planes. The cattle guard utilizes a revolutionary design in its side guards. By designing a side guard that adapts to variable size gate openings, clue to its hinged base, and using chains to attach to the existing fence posts, the present invention eliminates the need to install additional fencing or move gate posts. This design utilizes easy to use chains in lieu of traditional labor-intensive installation of barbed wire commonly used to connect most cattle guards to fences. The side guards fold out to fit virtually any size gate opening. The cattle guard, because it sits on the ground, allows no space for any size animal to become trapped and no mechanical parts to form pinch points, making it wildlife friendly, compared to existing products.

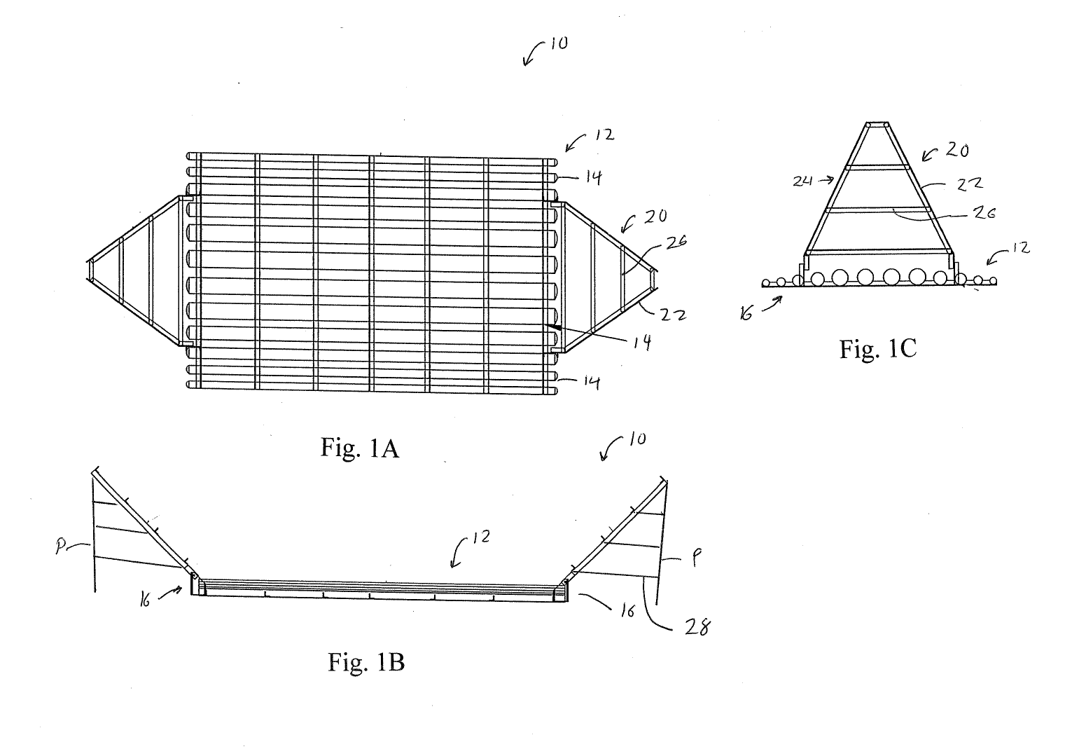

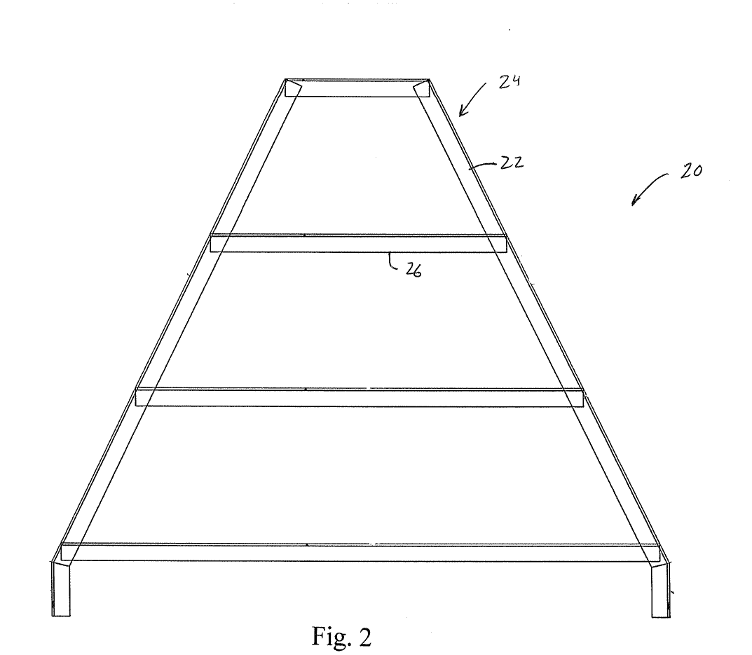

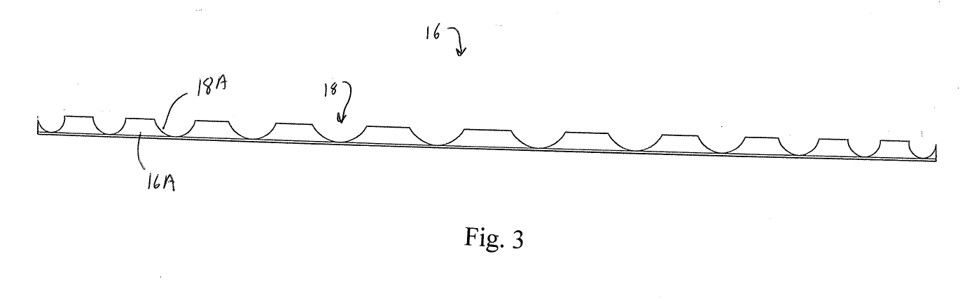

Referring now to FIGS. 1-3, one embodiment of a cattle guard 10 will be described. The cattle guard 10 may have a bottom grate section 12. The grate section 12 may be placed directly on top of the ground and therefore requires no pit/trench to be dug like in prior art designs. Further, since the cattle guard 10 sits on the ground, no space is created between the cattle guard 10 and the ground for any size animal to become trapped. The grate section 12 may be formed in an arced structure. The arced shape of the grate section 12 may allow for vehicles to travel over the cattle guard 10 while aiding in preventing animals from crossing the cattle guard 10.

The arced shape of the grate section 12 may be formed in several manners. In the present embodiment, the grate section 12 may be comprised of a plurality of rounded pipes 14. The rounded nature of the pipes 14 provide unsuitable footing for hoofed animals. The rounded nature of the pipes 14 makes it nearly impossible for a hoofed animal to walk across. The pipes 14 therefore provide a superior structure than square or flat materials used in most cattle guards. The rounded pipes 14 may be positioned so that adjacent pipes have spacing designed narrowly enough to prevent a large animal from stepping through to solid ground and wide enough to present unstable footing for a deterrent.

In accordance with the present embodiment, pipes 14 may be made of horizontally arranged capped steel pipes in a combination of various diameters. The pipes 14 may be arranged with spacing from approximately 0″ to 3.5″ between the tangents. The smaller diameter pipes 14 may be arranged at the outer edges with the diameters of the pipes 14 progressively increasing toward a central area of the grate section 12, creating an arc.

The pipes 14 may be held in position by side end members 16. The side end members 16 may be formed of a plate 16A. The plate 16A may be formed of a metal material such as steel, iron, or the like. The listing of the above materials is given as an example and should not be seen in a limiting manner. The plate 16A may have a plurality of cutouts 18. The cutouts 18 may be used to hold the pipes 14 within the plate 16A. The size and shape of the cutouts 18 may vary based on the size and shape of the pipes 14. In the present embodiment, the cutouts 18 may be a plurality of semi-circular cutouts 18A. Each of the semi-circular cutouts 18A may be sized to approximately fit the size of the respective pipe 14 positioned therein. The pipes 14 may further be secured within the cutouts 18. In accordance with one embodiment, the pipes 14 may be welded within the cutouts 18.

In accordance with one embodiment of the present invention, the plates 16A may be scalloped steel stringers welded perpendicular to the pipes 14 on the bottom side. The stringers are made of channel or angle iron or a suitable structural steel shape. The scalloping allows for the structural integrity to keep the pipes 14 at specified spacing, while allowing the pipes 14 to virtually sit on top of the ground, rendering virtually unlimited structural support.

A pair of end members 20 may be hingedly coupled to the grate section 12. In accordance with one embodiment, an end member 20 may be hingedly coupled to each end of the grate section 12. The end members 20 may be used to connect the cattle guard 10 to existing gate posts P. Since the end members 20 are hingedly coupled to the grate section 12, the end members 20 fold out to fit virtually any size gate opening.

In accordance with one embodiment, the end members 20 may be made of steel angle iron. The end members 20 may be formed of a plurality of arm members 22 welded to form a trapezoid-like assembly 24. Intermediate are members 26 may be spaced horizontally throughout the length of the trapezoid-like assembly 24.

The end members 20 span the width of the cattle guard with the base of the end members 20 pivoting on a hinge assembly welded to the ends of the cattle guard 10. From the pivot point the end members 20 slope upward and outward with the apex of the end members 20 leaning against and attaching to the existing gate posts P on either side.

The end members 20 may be attach with connectors 28 to the gate posts P. The connectors 28 may be rope, chains, or the like. The listing is given only as an example and should not be seen in a limiting manner. The connectors 28 may be spaced at approximately 1 foot horizontal increments from ground level upward. If chains are used as the connectors 28, the chains may be welded to the intermediate members 26 of the end members 20 and are designed to wrap around the existing gate posts P, and then re-attach at a notch cut into the intermediate member 26 at a designed attachment point. This horizontal spacing of the connectors 28 creates a fence-like barrier between the cattle guard 10 and the existing fence. In addition to creating a fence-like barrier for the livestock, these connectors 28 also provide support against lateral movement of the cattle guard 10.

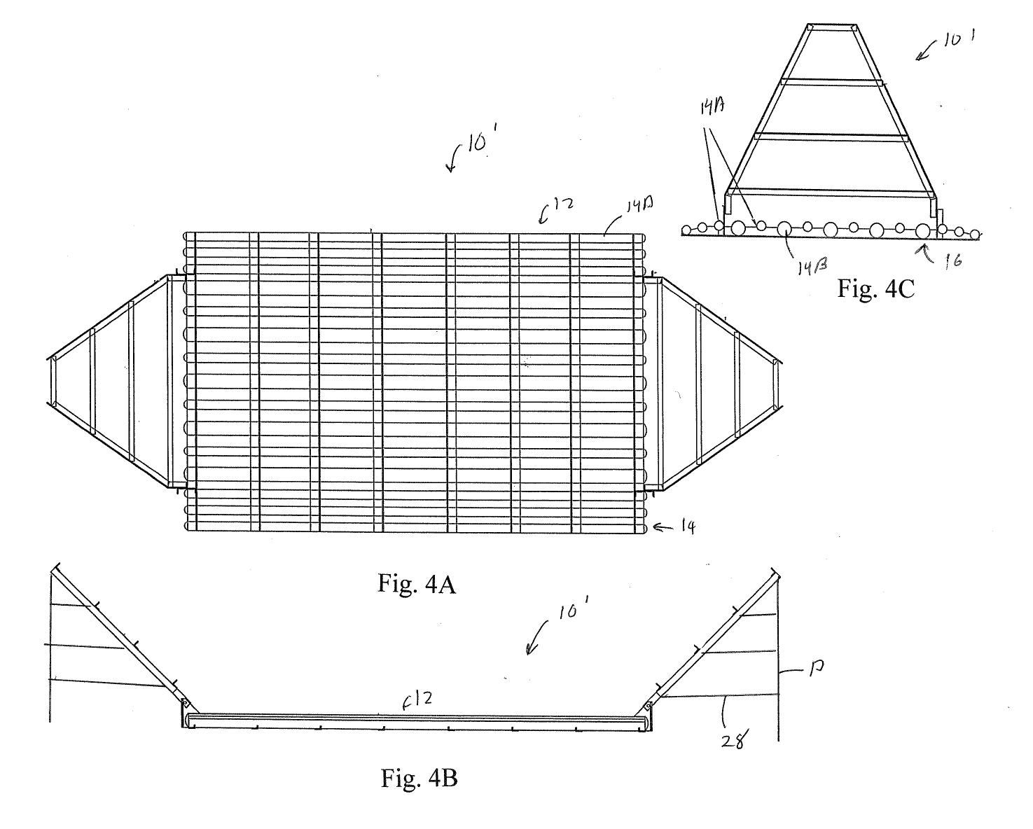

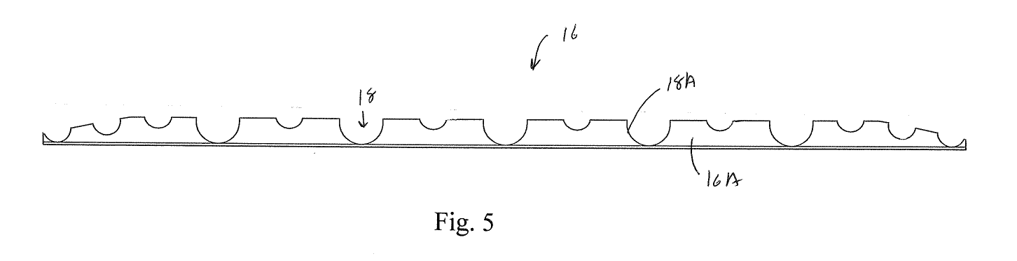

Referring now to FIGS. 4-5, another embodiment of a cattle guard 10′ will be described. The cattle guard 10′ is similar to the previous embodiment disclosed above. The cattle guard 10′ may have a bottom grate section 12. The grate section 12 may be placed directly on top of the ground and therefore requires no pit/trench to be dug like in prior art designs. Further, since the cattle guard 10′ sits on the ground, no space is created between the cattle guard 10′ and the ground for any size animal to become trapped. The grate section 12 may be formed in an arced structure. The arced shape of the grate section 12 may allow for vehicles to travel over the cattle guard 10′ while aiding in preventing animals from crossing the cattle guard 10′.

The arced shape of the grate section 12 may be formed in several manners. In the present embodiment, the grate section 12 may be comprised of a plurality of rounded pipes 14. The rounded nature of the pipes 14 provide unsuitable footing for hoofed animals. The rounded nature of the pipes 14 makes it nearly impossible for a hoofed animal to walk across. The pipes 14 therefore provide a superior structure that square or flat materials used in most cattle guards. The rounded pipes 14 may be positioned so that adjacent pipes have spacing designed narrowly enough to prevent a large animal from stepping through to solid ground and wide enough to present unstable footing for a deterrent.

In accordance with the present embodiment, pipes 14 may be made of horizontally arranged capped steel pipes in a combination of various diameters. The pipes 14 may be arranged with spacing from approximately 0″ to 3.5″ between the tangents. The smaller diameter pipes 14A may be arranged at the outer edges. Then, larger diameter pipes 14B alternating with smaller diameter pipes 14A may be positioned in a central area of the grate section 12.

The pipes 14 may be held in position by side end members 16. The side end members 16 may be formed of a plate 16A. The plate 16A may be formed of a metal material such as steel, iron, or the like. The listing of the above materials is given as an example and should not be seen in a limiting manner. The plate 16A may have a plurality of cutouts 18. The cutouts 18 may be used to hold the pipes 14 within the plate 16A. The size and shape of the cutouts 18 may vary based on the size and shape of the pipes 14. In the present embodiment, the cutouts 18 may be a plurality of semi-circular cutouts 18A. Each of the semi-circular cutouts 18A may be sized to approximately fit the size of the respective pipe 14 positioned therein. The depth of the cutouts 18 may be adjusted so that the grate section 12 may have the arced shape. The pipes 14 may further be secured within the cutouts 18. In accordance with one embodiment, the pipes 14 may be welded within the cutouts 18.

In accordance with one embodiment of the present invention, the plates 16A may be scalloped steel stringers welded perpendicular to the pipes 14 on the bottom side. The stringers are made of channel or angle iron or a suitable structural steel shape. The scalloping allows for the structural integrity to keep the pipes 14 at specified spacing, while allowing the pipes 14 to virtually sit on top of the ground, rendering unlimited structural support.

A pair of end members 20 may be hingedly coupled to the grate section 12. In accordance with one embodiment, an end member 20 may be hingedly coupled to each end of the grate section 12. The end members 20 may be used to connect the cattle guard 10 to existing gate posts P. Since the end members 20 are hingedly coupled to the grate section 12, the end members 20 fold out to fit virtually any size gate opening O.

In accordance with one embodiment, the end members 20 may be made of steel angle iron. The end members 20 may be formed of a plurality of arm members 22 welded to form a trapezoid-like assembly 24. Intermediate are members 26 may be spaced horizontally throughout the length of the trapezoid-like assembly 24.

The end members 20 span the width of the cattle guard with the base of the end members 20 pivoting on a hinge assembly welded to the ends of the cattle guard 10. From the pivot point the end members 20 slope upward and outward with the apex of the end members 20 leaning against and attaching to the existing gate posts P on either side.

The end members 20 may be attach with connectors 28 to the gate posts P. The connectors 28 may be rope, chains, or the like. The listing is given only as an example and should not be seen in a limiting manner. The connectors 28 may be spaced at approximately 1 foot horizontal increments from ground level upward. If chains are used as the connectors 28, the chains may be welded to the intermediate members 26 of the end members 20 and are designed to wrap around the existing gate posts P, and then re-attach at a notch cut C into the intermediate member 26 at a designed attachment point. This horizontal spacing of the connectors 28 creates a fence-like barrier between the cattle guard 10 and the existing fence. In addition to creating a fence-like barrier for the livestock, these connectors 28 also provide support against lateral movement of the cattle guard 10.

While embodiments of the disclosure have been described in terms of various specific embodiments, those skilled in the art will recognize that the embodiments of the disclosure can be practiced with modifications within the spirit and scope of the claims.

What is claimed is:

1. A cattle guard comprising:
a grate section, wherein the grate section is arced shaped and is positioned on a ground; and
an end member hingedly coupled to the grate section, the end member allowing the cattle guard to adjust to conform to different fence openings.

2. The cattle guard of claim 1, wherein the grate section comprises a plurality of pole members, the pole members arranged to form an arc.

3. The cattle guard of claim 2, wherein the grate section further comprises:
a pair of plate member; and
a plurality of cut-outs formed in each plate members, the cut-outs sized to secure the pole members therein.

4. The cattle guard of claim 2, wherein diameters of the plurality of pole members are arranged in an ascending order to form the arced shape.

5. The cattle guard of claim 1, wherein depths of the cut-outs are used to form the arced shape of the grate section.

6. The cattle guard of claim 1, wherein the end member comprises:
a plurality of arm members, wherein the plurality of arm members are arranged to form a trapezoid-like assembly; and
support arms members spaced horizontally throughout the length of the trapezoid-like assembly.

7. The cattle guard of claim 6, wherein each of the end members further comprises a plurality of chain-like members attached to the support arms to attach the end members to fence poles.

8. A cattle guard comprising:
a plurality of pole members, the pole members placed on a ground area and arranged to form an arc; and
a pair of end member hingedly coupled to a pair of sides of the pole members, the end members allowing the cattle guard to adjust to conform to different size fence openings.

9. The cattle guard of claim 8, further comprising:
a pair of plate member; and
a plurality of cut-outs formed in each plate members, the cut-outs sized to secure the pole members therein.

10. The cattle guard of claim 8, wherein diameters of the plurality of pole members are arranged in an ascending order to form the arc.

11. The cattle guard of claim 8, wherein diameters of the plurality of pole members are arranged from a first end to an apex of the arced shape in an ascending order and from the apex to a second end in a descending order.

12. The cattle guard of claim 9, wherein depths of the cut-outs are used to form the arc.

13. The cattle guard of claim 8, wherein each of the end members comprises:
a plurality of arm members, wherein the plurality of arm members are arranged to form a trapezoid-like assembly; and
support arms members spaced horizontally throughout the length of the trapezoid-like assembly.

14. The cattle guard of claim 13, wherein each of the end members further comprises a plurality of chain-like members attached to the support arms to attach the end members to fence poles.

15. A cattle guard comprising:
a grate section, wherein the grate section is arced shaped and is positioned on a ground wherein the grate section comprises:
a plurality of pole members, the pole members arranged to form an arc;
a pair of plate member; and
a plurality of cut-outs formed in each plate members, the cut-outs sized to secure the pole members therein; and
an end member hingedly coupled to the grate section, the end member allowing the cattle guard to adjust to conform to different fence openings.

16. The cattle guard of claim 15, wherein diameters of the plurality of pole members are arranged in an ascending order to form the arced shape.

17. The cattle guard of claim 15, wherein depths of the cut-outs are used to form the arced shape of the grate section.

18. The cattle guard of claim 15, wherein the end member comprises:
a plurality of arm members, wherein the plurality of arm members are arranged to form a trapezoid-like assembly; and
support arms members spaced horizontally throughout the length of the trapezoid-like assembly.

19. The cattle guard of claim 18, wherein each of the end members further comprises a plurality of chain-like members attached to the support arms to attach the end members to fence poles.

20. The cattle guard of claim 15, wherein spacing between adjacent poles is from approximately 0″ to 3.5″ between tangents.
